(19) United States
(12) Patent Application Publication
(10) Pub. No.: US 2021/0371192 A1
(43) Pub. Date: Dec. 2, 2021

(54) ICE CREAM PACKAGING MATERIAL USING HORIZONTAL DISPOSABLE PLASTIC FILM MOLD AS INNER PACKAGING MATERIAL

(71) Applicant: Jung Han CHAE, Seoul (KR)

(72) Inventor: Jung Han CHAE, Seoul (KR)

(21) Appl. No.: 17/281,595

(22) PCT Filed: Sep. 25, 2019
(86) PCT No.: PCT/KR2019/012430

§ 371 Date: Mar. 31, 2021

(30) Foreign Application Priority Data
Oct. 2, 2018 (KR) 10-2018-0117396

(51) Int. Cl. B65D 85/78; A23G 9/50; A23G 9/22; B65D 75/32; B65D 75/52

(52) U.S. Cl. CPC B65D 85/78; A23G 9/503; A23G 9/221; A23G 2220/12; B65D 75/522; B65D 2575/3209; B65D 2575/54; B65D 75/326

(57) ABSTRACT

The present invention relates to a method of packaging character ice cream using a horizontal disposable plastic film mold as an inner packaging material. Ice cream packaging material uses a horizontal disposable plastic film mold as the inner packaging material, in which a horizontal disposable character mold for maintaining a shape of bar-type character ice cream is made by forming a plastic film in a character shape or other stereoscopic shapes. Ice cream liquid is injected into the horizontal disposable plastic film mold and then frozen, and the ice cream is packaged together with a rear reinforcement material without separating the ice cream from the horizontal disposable plastic film mold, thereby preventing a surface of the ice cream from being oxidized or preventing the character shape from being damaged.

### TECHNICAL FIELD

The present invention relates to a method of packaging character ice cream using a horizontal disposable plastic film mold as an inner packaging material, and more particularly, to an ice cream packaging material using a horizontal disposable plastic film mold as an inner packaging material, in which a horizontal disposable character mold for maintaining a shape of bar-type character ice cream is made by forming a plastic film in a character shape or other stereoscopic shapes, an ice cream liquid is injected into the horizontal disposable plastic film mold and then frozen, and the ice cream is packaged together with a rear reinforcement material without separating the ice cream from the horizontal disposable plastic film mold, thereby preventing a surface of the ice cream from being oxidized or preventing the character shape from being damaged.

### BACKGROUND ART

Ice cream is a food manufactured by freezing an ice cream liquid made by mixing milk, sugar, fruit, and other additives. Typically, the ice cream is manufactured by filling a stainless-steel mold, formed in a vertical direction, with the ice cream liquid, fixing a stick into an upper end of the ice cream liquid in the vertical direction, and then freezing the ice cream liquid. In the case of using the vertical mold, the vertical mold generally has a structure that is tapered downward so that the frozen ice cream may be removed from the mold.

FIG. 1 is an exemplified view illustrating an example of a typical vertical mold made of stainless steel.

In the case of using the vertical mold, there is a disadvantage in that the ice cream having a stereoscopic shape such as a character shape cannot be manufactured.

On the other hand, recently, ice cream with complex designs such as character shapes is being released, and such ice cream is manufactured using various types of horizontal molds made of silicone.

FIG. 2 is an exemplified view illustrating an example of a typical horizontal mold made of silicone.

Typically, the horizontal mold has a depth of 30 mm or less and has a structure having a horizontal cross-sectional area greater than the depth. In the case of the vertical mold, the stick is inserted downward from above, whereas in the case of the horizontal mold, the stick is inserted laterally and then positioned in the horizontal direction. Typically, since the horizontal mold is made of silicone, the ice cream may be easily separated from the horizontal mold after the ice cream is frozen. In addition, because the horizontal mold may have various curved shapes at a lower end thereof, even the ice cream having a character shape may be manufactured using the horizontal mold.

Meanwhile, in general, in the case of both the vertical mold and the horizontal mold, when the ice cream is frozen, the ice cream is separated from the mold and then packaged. In this process, because a region of the ice cream corresponding to the area in contact with the mold is in contact with air, a surface of the ice cream is dried and oxidized due to contact with oxygen. The dried and oxidized surface of the ice cream degrade the quality of the ice cream.

Further, when the ice cream having the character shape is removed from the mold and then packaged, the character shape is likely to be damaged by external pressure.

Further, there is also a problem in that frost is formed on the surface of the ice cream being in contact with the air. In order to solve the above-mentioned problems, a method of coating the surface of the ice cream with a coating agent such as chocolate is used after separating the ice cream from the mold.

FIG. 3 is a perspective view illustrating a structure of ice cream coated with a typical coating agent.

However, in the case of the above-described method, a consumer needs to necessarily eat the coating agent such as chocolate when eating the ice cream. For this reason, there is a disadvantage in that the consumer cannot feel inherent flavor of the ice cream. In addition, since the inside of the ice cream is not visible, there is a limitation in terms of design of the ice cream.

Meanwhile, as a typical method of packaging a bar-type ice cream, there is used a method of packaging, with a vinyl material, the ice cream itself separated from the mold or a method of packaging, with a vinyl material, the ice cream coated with the coating agent.

FIG. 4 is a perspective view illustrating an ice cream packaging material in the related art.

The manufactured ice cream is sealed with a packaging material 20, and ice cream 21 embedded with a stick 22 is wrapped with a packaging film 23, and the ice cream 21 in the frozen state is sold. The consumer opens the packaging film 23 to eat the ice cream 21 in the packaging film 23.

### DISCLOSURE

### Technical Problem

The present invention has been made in an effort to solve the above-mentioned problems, and an object of the present invention is to provide an ice cream packaging material using a horizontal disposable plastic film mold as an inner packaging material, in which a horizontal disposable mold having a predetermined stereoscopic shape is formed using a specific plastic film, an ice cream liquid is injected into the mold and then frozen, and the frozen ice cream is packaged together with the disposable mold without separating the frozen ice cream from the horizontal disposable mold, thereby minimizing the amount of air to be in contact with the ice cream and enabling a consumer to identify a shape of the ice cream through the transparent disposable mold.

Another object of the present invention is to an ice cream packaging material using a horizontal disposable plastic film mold as an inner packaging material, in which ice cream is packaged with a reinforcement plate which is in direct contact with a rear surface of the ice cream, thereby minimizing contact between the ice cream and air.

Still another object of the present invention is to an ice cream packaging material using a horizontal disposable plastic film mold as an inner packaging material, in which a bent stick is used as a stick mounted at an upper end of the horizontal disposable mold in order to enable ice cream to be positioned appropriately in the ice cream packaging material.

Yet another object of the present invention is to an ice cream packaging material using a horizontal disposable plastic film mold as an inner packaging material, in which unevenness is formed on a surface of a stick and a surface of a disposable mold in order to prevent an ice cream liquid from leaking into a space, in which the stick is mounted, during a process of injecting the ice cream liquid.

### Advantageous Effects

The present invention is advantageous in that since the ice cream is packaged together with the disposable plastic film mold, it is possible to minimize contact between the ice cream and the air during distribution and sale of the ice cream to prevent a surface of the ice cream from being dried and prevent the ice cream from being oxidized, thereby preventing frost from being formed on the surface of the ice cream and maintaining a state of the surface of the ice cream having a character shape or other stereoscopic shapes.

In addition, since a transparent soft material is used to manufacture the horizontal disposable mold, there is an advantage in that it is possible to enable a consumer to easily identify a shape and a color of the ice cream from the outside, and it is possible to enable a consumer to easily separate the packaging material from the ice cream, thereby enabling the consumer to eat the ice cream without damaging an external appearance of the ice cream.

### DESCRIPTION OF DRAWINGS

FIG. 1 is an exemplified view illustrating an example of a typical vertical mold made of stainless steel.

FIG. 2 is an exemplified view illustrating an example of a typical horizontal mold made of silicone.

FIG. 3 is a perspective view illustrating a structure of ice cream coated with a typical coating agent.

FIG. 4 is a perspective view illustrating an ice cream packaging material in the related art.

FIG. 5 is a perspective view illustrating a packaging material according to an embodiment of the present invention.

FIG. 6 is a top plan view illustrating a structure of the packaging material according to the present invention.

FIG. 7 is a cross-sectional side view illustrating a structure of the packaging material according to the present invention.

FIG. 8 is a perspective view illustrating a structure of a horizontal disposable mold.

FIG. 9 is a perspective view illustrating a structure of a stick.

FIG. 10 is a conceptual view illustrating a process of injecting an ice cream liquid into the disposable mold.

FIG. 11 is a cross-sectional side view illustrating a state in which the ice cream enclosed by the disposable mold is placed on a reinforcement plate.

FIG. 12 is a cross-sectional side view illustrating a state in which the ice cream, which is enclosed by the disposable mold and placed on the reinforcement plate, is packaged by being inserted into a packaging film.

FIG. 13 is a perspective view illustrating a structure of a stick formed with outflow prevention unevenness.

FIG. 14 is a perspective view illustrating a structure of a disposable mold formed with outflow prevention unevenness.

FIG. 15 is a cross-sectional side view illustrating a state in which the disposable mold engages with the stick having the outflow prevention unevenness.

FIG. 16 is a perspective view illustrating a structure in which a surface of a stick is enclosed by silicone.

FIG. 17 is a photograph made by capturing an image of a die for forming the disposable mold.

FIG. 18 is a photograph made by capturing an image of the disposable mold formed using the die illustrated in FIG. 17.

FIG. 19 is a photograph made by capturing an image of ice cream manufactured using the disposable mold as an inner packaging material.

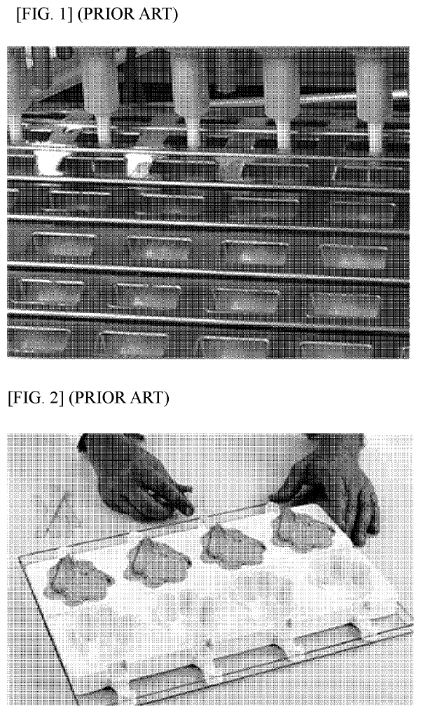

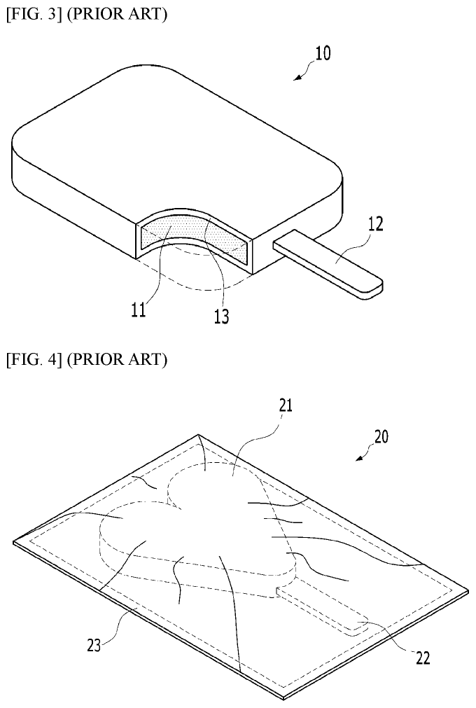

### DESCRIPTION OF MAIN REFERENCE NUMERALS OF DRAWINGS

100: Packaging material 102: Ice cream
104: Stick 106: Disposable mold
108: Reinforcement plate 110: Packaging film

### BEST MODE

The present invention, which is contrived to solve the above-mentioned problems, relates to an ice cream packaging material configured to seal ice cream to prevent contact between the ice cream and outside air in a state in which the ice cream is frozen. The ice cream packaging material includes: a disposable mold 106 made of a transparent material and configured to store frozen ice cream 102; a stick 104 inserted from a lateral side of the disposable mold 106 and having a body partially embedded in the ice cream 102; a reinforcement plate 108 configured to cover an opened side of the disposable mold 106; and a packaging film 110 having an internal space and configured to seal an outlet, in a state in which the disposable mold 106 and the stick 104 are inserted into the internal space, in order to prevent contact between the ice cream 102 and outside air.

The disposable mold 106 includes a casing 106a having a storage space 106b therein and opened at one side thereof; and a stick inlet 106c formed in a part of a wall surface of the casing 106a and extending to have a space having a predetermined size. The disposable mold 106 has a thickness of 200 to 300 μm and is formed of any one of a single film made of low-density polyethylene (LDPE) resin and a laminated film made of LDPE and polypropylene (PP).

The stick 104 includes an inner embedded portion 104a configured to be embedded in the ice cream 102; an outer exposed portion 104c exposed to the outside of the ice cream 102 to enable a consumer to hold the outer exposed portion 104c; and an inclined portion 104b configured to connect the inner embedded portion 104a and the outer exposed portion 104c and formed to be inclined in a straight or curved state.

The stick 104 further includes unevenness 104d protruding from a surface of the stick 104 to prevent an outflow of an ice cream liquid.

The stick 104 further includes a soft ring 104e attached to the surface of the stick 104 to prevent an outflow of the ice cream liquid.

### MODE FOR INVENTION

Hereinafter, “an ice cream packaging material using a horizontal disposable plastic film mold as an inner packaging material” (hereinafter, referred to as a ‘packaging material’) according to an embodiment of the present invention will be described with reference to the drawings.

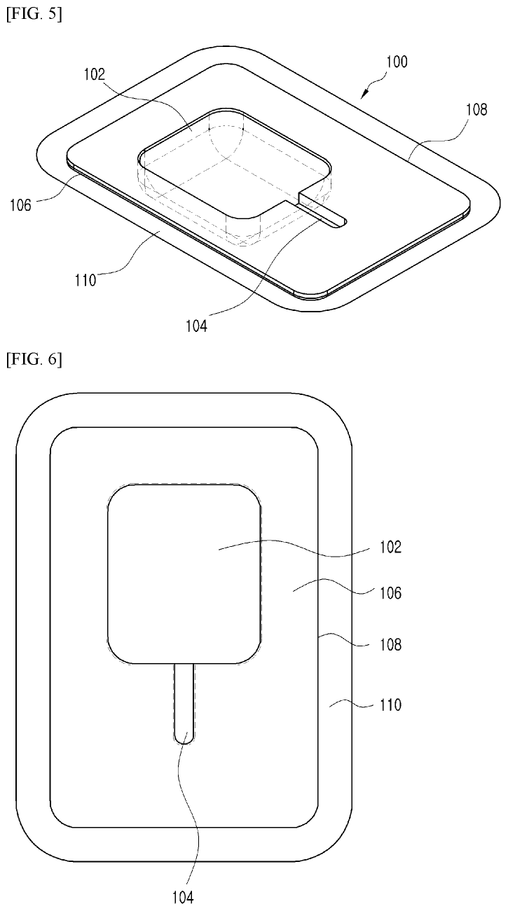

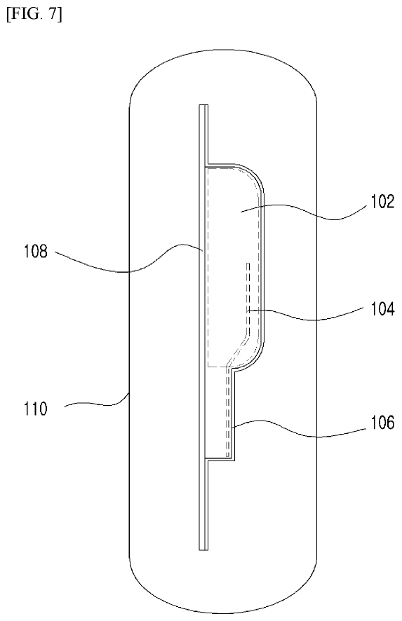

FIG. 5 is a perspective view illustrating the packaging material according to the embodiment of the present invention, FIG. 6 is a top plan view illustrating a structure of the packaging material according to the present invention, and FIG. 7 is a cross-sectional side view illustrating a structure of the packaging material according to the present invention.

A packaging material 100 according to an embodiment of the present invention is used in processes such as molding, freezing, packaging, and delivery during a process of providing the ice cream 102 to a final consumer. The consumer removes the packaging material 100 according to the present invention to take out the ice cream 102 packaged in the packaging material 100. In this process, the horizontal disposable plastic film mold 106 (hereinafter, referred to as a ‘disposable mold’) needs to be separated from the ice cream 102 while maintaining a shape of the ice cream 102 without any damage to the surface of the ice cream 102.

In particular, because the disposable mold should not be deformed even at a low temperature of −20° C. or lower, the disposable mold needs to have low temperature resistance. Because the disposable mold should not be in close contact with the surface of the ice cream 102 during a process of separating the ice cream 102 from the disposable mold, the disposable mold may be made of a material with a very small surface frictional coefficient.

In addition, the disposable mold may be formed of a soft film instead of a hard film so that the disposable mold may be easily removed.

In addition, in order to maintain the shape of the ice cream after the ice cream is molded, the disposable mold 106 may have a predetermined thickness of 0.20 mm to 0.30 mm or more to the extent that the disposable mold 106 may be removed.

In addition, the disposable mold 106 needs to prevent contact between a front surface of the ice cream 102 and air before the consumer finally eats the ice cream 102.

The ice cream 102 is manufactured in various shapes such as a quadrangular shape, a circular shape, and a rhombic shape. The ice cream 102 may also have shapes such as characters, fruit, and cookies in addition to the above-mentioned shapes. The disposable mold 106 has a space having a shape identical to one of the above-mentioned shapes. To this end, the disposable mold 106 needs to be formed of a thermoplastic film capable of being molded by heat.

Meanwhile, the disposable mold 106 surrounds the ice cream 102, and the disposable mold 106 in which the ice cream 102 is accommodated is sealed with the packaging film 110. The disposable mold 106 is manufactured by a film forming machine using a plastic film for food having hardness enough to maintain a predetermined shape the plastic film.

Further, an upper end of the disposable mold is opened such that the ice cream liquid is injected into the disposable mold. One surface of the ice cream 102 is exposed through the opened side of the disposable mold, and the reinforcement plate 108 is used to prevent one surface of the ice cream from being exposed to the outside.

Further, the ice cream 102 is manufactured in a state in which the stick 104, which is to be held by the consumer's hand, is embedded in the ice cream 102. The stick 104 is made of plastic or wood like typical ice cream. The stick 104 according to the present invention may have a bent shape in order to prevent a leakage of the ice cream liquid during the process of molding the ice cream 102 and to allow a part of the stick 104 to be embedded in the ice cream 102. This configuration will be described below.

The ice cream 102 embedded with the stick 104 is embedded in the disposable mold 106, and the reinforcement plate 108 is in close contact with the opened side of the disposable mold 106. The reinforcement plate 108 is a portion on which an advertising description or a product description is marked. The reinforcement plate 108 is provided to protect one surface of the ice cream 102 and configured as a comparatively thick paper or plastic plate.

Further, the packaging film 110 seals the ice cream enclosed by the disposable mold 106 placed on the reinforcement plate 108 to block the ice cream from the outside. To this end, a periphery of the disposable mold 106 is slightly smaller than or equal to a periphery of the reinforcement plate 108. Therefore, the packaging film 110 fixes the disposable mold 106 and the stick 104 disposed inside the packaging film 110 in a state in which the disposable mold 106 and the stick 104 are isolated from the outside.

The packaging film 110 is a general film used to vacuum-package food and made of synthetic resin that blocks air and is not easily damaged by impact. In some instances, the interior of the packaging film 110 may be filled with nitrogen or the like to prevent a deterioration of the ice cream and enable the packaging film 110 to withstand external impact.

In addition, a product description may be printed on the packaging film 110.

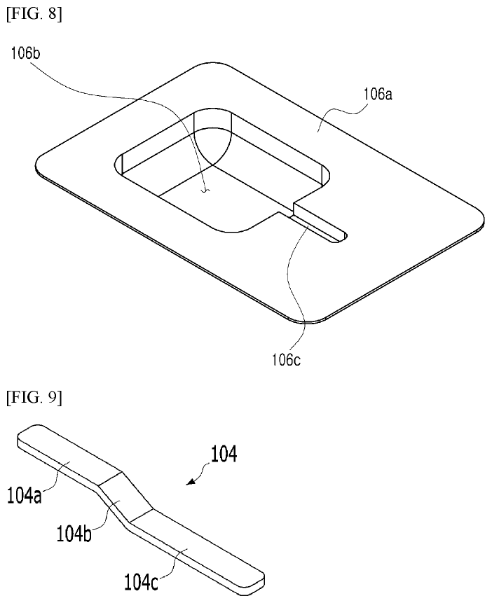

FIG. 8 is a perspective view illustrating a structure of the horizontal disposable mold.

The disposable mold 106 serves to maintain a shape of the front surface of the ice cream 102 and prevent direct contact between outside air and the ice cream. The disposable mold 106 also serves as a container that is separable such that the consumer may easily remove the disposable mold 106 to eat the ice cream.

The disposable mold 106 includes the casing 106a having therein the storage space 106b having a predetermined size and a predetermined shape. The casing 106a needs to have a small surface frictional coefficient in order to prevent the ice cream 102 from being attached to the casing 106a. The casing 106a needs to be made of a soft material so as to be easily separated from the ice cream and needs to have firmness enough to maintain a predetermined shape thereof. To this end, the disposable mold 106 is made of a transparent plastic material having a thickness of about 200 to 300 μm. Particularly, the disposable mold 106 may be formed of a single film made of low-density polyethylene (LDPE) resin or a laminated film made of LDPE and polypropylene (PP).

The stereoscopic shape of the disposable mold 106 is formed generally by heating the plastic film with a heater and then blowing air into an upper end of the plastic film or by sucking air through a hole formed in a die positioned at a lower end of the disposable mold. In addition, the stereoscopic shape of the disposable mold may be made by pressing the disposable mold with a press.

The ice cream liquid is injected into the storage space 106b in the casing 106a, and then the ice cream liquid is frozen at a low temperature, thereby forming the ice cream 102 in a solid state. Therefore, the disposable mold needs to be made of a material that is not damaged even at a low temperature. In addition, the disposable mold needs to be opened at an upper side thereof so that the ice cream liquid may be injected into the storage space 106b in the casing 106a.

The stick inlet 106c is formed in a part of the wall surface of the casing 106a and extends to have a space having a predetermined size. The stick inlet 106c is made to have a size equal to a width or a thickness of the stick 104. In general, a depth of the stick inlet 106c is relatively smaller than a depth of the storage space 106b in which a main body of the ice cream 102 is molded.

The drawings according to the present invention illustrate that the casing 106a has a comparatively flat cube shape without having any additional shape therein. However, in order to form various character shapes on the ice cream 102, stereoscopic shapes corresponding to the character shapes on the ice cream 102 may be formed on the wall or bottom surface of the casing 106a.

In addition, the drawings illustrate that the entire upper side of the casing 106a is opened in order to facilitate the injection of the ice cream liquid and enable the consumer to easily remove the disposable mold 106 to eat the ice cream 102. However, the casing 106a may be manufactured by opening a part of a lateral wall body in accordance with the property or shape of the ice cream 102. A part of the surface of the frozen ice cream 102 is exposed through the opened side of the casing 106a, and the reinforcement plate 108 covers and protects the opened side of the casing 106a.

Meanwhile, FIG. 9 is a perspective view illustrating a structure of the stick.

The stick 104 having a partially bent shape is used for the ice cream 102 according to the present invention. A typical mold used to manufacture ice cream is a vertical mold. In the case of the vertical mold, a straight-rod-shaped stick is inserted from above to below, and an ice cream liquid is injected from above, such that the ice cream is molded in such a manner that a level of the ice cream liquid is raised from below. During the use of this process, the straight-rod-shaped stick may be used because it is acceptable as long as the stick is fixed above. However, during the use of the disposable horizontal mold formed of the film according to the present invention, the bent stick 104 is used such that a part of the stick 104 may be embedded in the ice cream 102.

The stick 104 according to the present invention includes the inner embedded portion 104a at the front side of the stick 104, the outer exposed portion 104c at the rear side of the stick 104, and the inclined portion 104b formed between the inner embedded portion 104a and the outer exposed portion 104c.

Each of the inner embedded portion 104a and the outer exposed portion 104c may have a cross section having a rectangular shape, a circular shape, or an elliptical shape. The inner embedded portion 104a is a portion to be inserted into the frozen ice cream 102, and the outer exposed portion 104c is a portion to be exposed to the outside of the ice cream 102 so as to be held by the consumer's hand.

The inclined portion 104b is a portion formed to be inclined straight at a predetermined angle or curved and provided to connect the inner embedded portion 104a and the outer exposed portion 104c. The inclined portion 104b allows two opposite ends of the stick 104 to be placed on imaginary planes spaced apart from each other at a predetermined distance.

As illustrated in FIG. 7, the stick 104 is inserted into the frozen ice cream 102 in the disposable mold 106. In this case, a surface of the outer exposed portion 104c is in close contact with the reinforcement plate 108. If there is no inclined portion 104b, the inner embedded portion 104a is also in close contact with the reinforcement plate 108. In this case, the surface of the stick 104 is exposed to the outside of the ice cream 102, and as a result, the stick 104 cannot rigidly fix the ice cream 102. In order to solve the above-mentioned problem, the inclined portion 104b is bent by a distance at which the inner embedded portion 104a is spaced apart from the reinforcement plate 108.

A method of packaging the ice cream 102 using the above-mentioned constituent elements will be sequentially described.

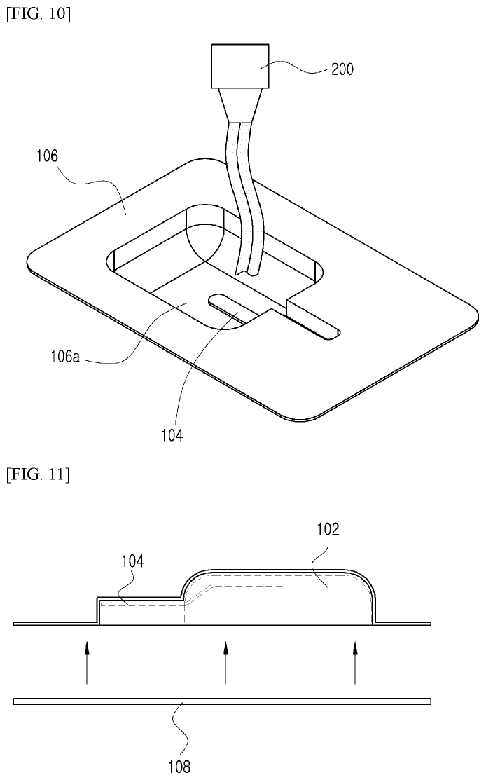

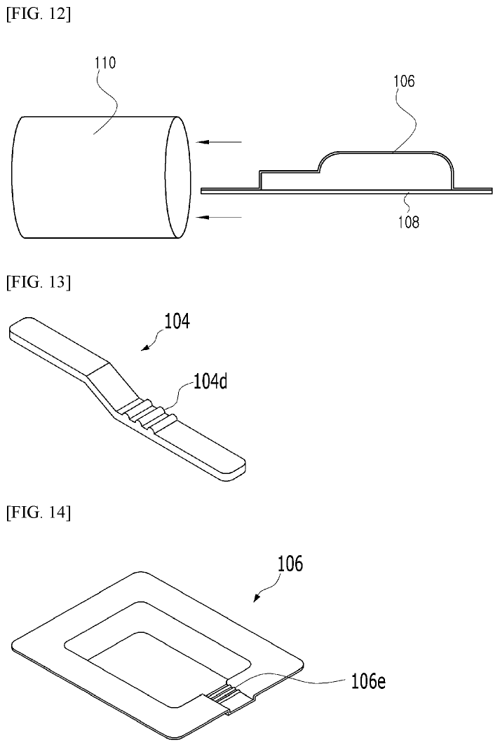

FIG. 10 is a conceptual view illustrating a process of injecting the ice cream liquid into the disposable mold, FIG. 11 is a cross-sectional side view illustrating a state in which the ice cream enclosed by the disposable mold is placed on the reinforcement plate, and FIG. 12 is a cross-sectional side view illustrating a state in which the ice cream enclosed by the disposable mold placed on the reinforcement plate is packaged by being inserted into the packaging film.

First, the ice cream liquid is injected into the storage space 106b in the state in which the outer exposed portion 104c of the stick 104 is fixed to the stick inlet 106c of the disposable mold 106. An injector 200 injects the ice cream liquid through the opened side of the casing 106a from above. Further, the stick 104 is mounted inside the casing 106a from the lateral side of the casing 106a, and in this state, the inner embedded portion 104a and the inclined portion 104b are inserted into the casing 106a.

The ice cream liquid is injected twice or more in accordance with the shape of the ice cream 102, and the ice cream liquid is repeatedly frozen, such that specific shapes or colors may be separately implemented.

When the disposable mold 106 into which the ice cream liquid is injected is frozen, the ice cream 102 is made in a state in which the outer exposed portion 104c is exposed to the outside, as illustrated in FIG. 11. In this case, the disposable mold 106 surrounds all the remaining surfaces except for the upper surface of the ice cream 102.

Further, the reinforcement plate 108 is attached to the portion of the disposable mold 106 where the ice cream 102 is exposed. In this case, the rear surface of the ice cream 102, which is exposed to the outside, is in contact with the reinforcement plate 108. The outer exposed portion 104c of the stick 104 is in contact with the reinforcement plate 108 or is very close to the reinforcement plate 108.

Next, as illustrated in FIG. 12, the ice cream 102 embedded with the stick 104, enclosed by the disposable mold 106, and placed on the reinforcement plate 108 is inserted into the packaging film 110.

When the disposable mold 106 in which the ice cream 102 is molded is inserted into the packaging film 110, the inlet of the packaging film 110 is thermally compressed and sealed. During the process of sealing the packaging film through the thermal compression, air may be discharged from the packaging film or filling gas may be injected into the packaging film.

The ice cream 102 packaged with the packaging material 100 manufactured by the above-mentioned method is distributed in a freezing facility. The consumer may remove the packaging film 110 and the reinforcement plate 108 and then remove the disposable mold 106 to eat the ice cream 102. Further, the consumer may identify the shape and the color of the ice cream 102 through the transparent disposable mold 106 and the transparent packaging film 110.

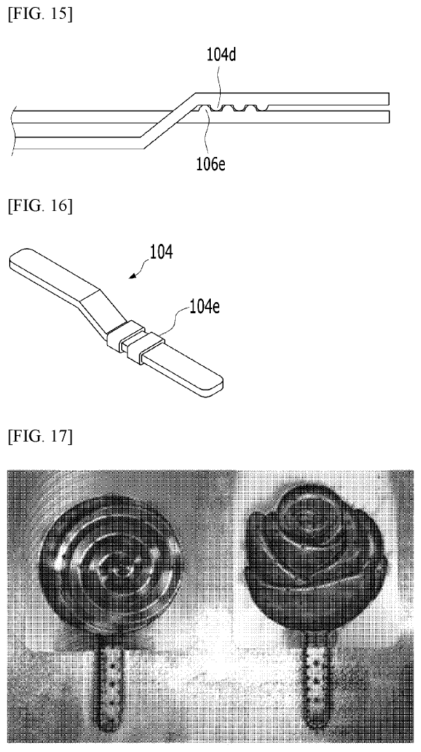

Meanwhile, FIG. 13 is a perspective view illustrating a structure of a stick formed with outflow prevention unevenness, FIG. 14 is a perspective view illustrating a structure of a disposable mold formed with outflow prevention unevenness, FIG. 15 is a cross-sectional side view illustrating a state in which the disposable mold engages with the stick having the outflow prevention unevenness, and FIG. 16 is a perspective view illustrating a state in which a surface of the stick is enclosed by silicone.

In order to manufacture the ice cream 102 according to the present invention, the ice cream liquid needs to be injected into the disposable mold 106 in the state in which the stick 104 is mounted in the horizontal direction. Because the stick 104 is placed in the horizontal direction and the disposable mold 106 has a comparatively flat stereoscopic shape, the ice cream liquid, which is not yet frozen, may flow outward along a lower surface of the stick 104. In this case, an outer portion of the ice cream 102 may not be smooth during the freezing process. In order to prevent this situation, the stick 104 needs to have an outflow prevention structure.

In the present invention, the outflow prevention unevenness 104d is formed on the surface of the stick 104. The unevenness 104d includes a plurality of protruding portions each having a predetermined height in a horizontal direction based on a longitudinal direction of the stick 104.

In addition, outflow prevention unevenness 106e, which corresponds to the unevenness 104d, is also formed on a surface of a stick stand 106d of the disposable mold 106.

The stick 104 and the disposable mold 106, which are formed with the pieces of unevenness corresponding to one another, define projections to prevent the ice cream liquid from easily passing. Because of these projections, the ice cream liquid does not flow outward during the injection process.

In some instances, without forming the unevenness 104d on the surface of the stick 104, the outflow prevention projections may be made by winding a soft ring 104e. FIG. 16 illustrates this configuration. The same effect may be obtained by attaching the ring 104e made of a soft material such as silicone, rubber, or vinyl to the surface of the stick 104.

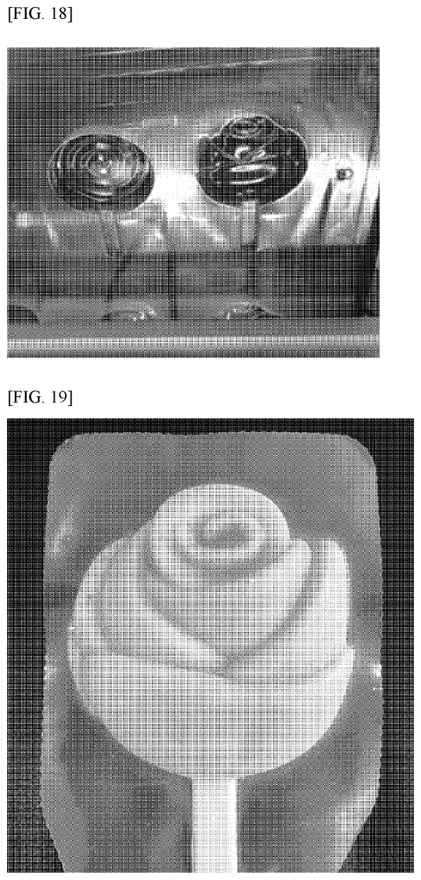

Meanwhile, FIG. 17 is a photograph made by capturing an image of a die for forming the disposable mold, FIG. 18 is a photograph made by capturing an image of the disposable mold formed using the die illustrated in FIG. 17, and FIG. 19 is a photograph made by capturing an image of ice cream manufactured using the disposable mold as an inner packaging material.

As illustrated in FIG. 17, the disposable mold 106 according to the present invention is formed of a plastic film. The disposable mold is formed in an integrated shape using a method of sucking air through a hole formed in a die manufactured to have a character shape or a stereoscopic shape.

By sucking the air, the plastic film placed on the die is brought into contact an inner surface of the die, and thus the plastic film is processed by the heated die so as to have a shape identical to the stereoscopic shape formed in the die.

After the disposable mold is completely formed, the suction of the air is stopped, such that the disposable mold 106 is separated from the die.

While the exemplary embodiment of the present invention has been described above with reference to the accompanying drawings, those skilled in the art will understand that the above-mentioned technical configuration of the present invention may be carried out in other specific forms without changing the technical spirit or the essential features of the present invention. Accordingly, it should be understood that the aforementioned exemplary embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

1. An ice cream packaging material using a horizontal disposable plastic film mold as an inner packaging material, the ice cream packaging material being configured to seal ice cream to prevent contact between the ice cream and outside air in a state in which the ice cream is frozen, the ice cream packaging material comprising:
a disposable mold made of a transparent material and configured to store frozen ice cream;
a stick inserted from a lateral side of the disposable mold and having a body partially embedded in the ice cream;
and
a packaging film having an internal space and configured to seal an outlet, in a state in which the disposable mold and the stick are inserted into the internal space, in order to prevent contact between the ice cream and outside air.

2. The ice cream packaging material of claim 1, wherein the disposable mold comprises:
a casing having a storage space therein and opened at one side thereof; and
a stick inlet formed in a part of a wall surface of the casing and extending to have a space having a predetermined size, and
wherein the disposable mold has a thickness of 200 to 300 μm and is formed of any one of a single film made of low-density polyethylene (LDPE) resin and a laminated film made of LDPE and polypropylene (PP).

3. The ice cream packaging material of claim 1, wherein the stick comprises:
an inner embedded portion configured to be embedded in the ice cream;
an outer exposed portion exposed to the outside of the ice cream to enable a consumer to hold the outer exposed portion; and
an inclined portion configured to connect the inner embedded portion and the outer exposed portion and formed to be inclined in a straight or curved state.

4. The ice cream packaging material of claim 3, further comprising:
unevenness protruding from a surface of the stick to prevent an outflow of an ice cream liquid.

5. The ice cream packaging material of claim 3, further comprising:
a reinforcement plate configured to cover an opened side of the disposable mold.
